(19) United States
(12) Patent Application Publication
(10) Pub. No.: US 2025/0056255 A1
(43) Pub. Date: Feb. 13, 2025

(54) METHOD AND APPARATUS FOR MEASUREMENT CONFIGURATION IN WIRELESS COMMUNICATION SYSTEM

(71) Applicant: SAMSUNG ELECTRONICS CO., LTD., Suwon-si (KR)

(72) Inventors: Yanze FU, Beijing (CN); Runsen TANG, Beijing (CN); Haijie QIU, Beijing (CN); Yiran JIN, Beijing (CN)

(21) Appl. No.: 18/798,705

(22) Filed: Aug. 8, 2024

(30) Foreign Application Priority Data
Aug. 9, 2023 (CN) 202311002194.4

(51) Int. Cl. H04W 24/02; H04W 8/22; H04W 16/28; H04W 36/08; H04W 36/24; H04W 64/00

(52) U.S. Cl. CPC H04W 24/02; H04W 8/22; H04W 16/28; H04W 36/08; H04W 36/249; H04W 64/00

(57) ABSTRACT

The disclosure relates to a 5G or 6G communication system for supporting a higher data transmission rate. Embodiments of the present disclosure provide a method performed by a user equipment (UE) in a wireless communication system, the method comprising: transmitting, to a serving node, assistance information for a configuration of measurement configuration information related to radio resource management (RRM); and receiving, from the serving node, the measurement configuration information.

### CROSS-REFERENCE TO RELATED APPLICATION

This application claims priority under 35 U.S.C. § 119(a) to Chinese Patent Application Serial No. 202311002194.4, which was filed in the Chinese Patent Office on Aug. 9, 2023, the entire disclosure of which is incorporated herein by reference.

### BACKGROUND

### 1. Field

The embodiments of the present disclosure relate to the technical field of wireless communication, and in particular to a method executed by a user equipment in a wireless communication system, and a user equipment.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### SUMMARY

In order to better satisfy the wireless communication requirements, the embodiments of the present disclosure provide the following technical solutions.

In one aspect, an embodiment of the present disclosure provides a method performed by a user equipment (UE) in a wireless communication system including transmitting, to a serving node, assistance information for a configuration of measurement configuration information related to radio resource management (RRM); and receiving, from the serving node, the measurement configuration information.

In one aspect, an embodiment of the present disclosure provides a method performed by a serving node in a wireless communication system including receiving, from a user equipment (UE), assistance information for a configuration of measurement configuration information related to radio resource management (RRM); and transmitting, to the UE, the measurement configuration information.

In one aspect, an embodiment of the present disclosure provides a user equipment in a wireless communication system including a transceiver; and at least one processor coupled to the transceiver and configured to: transmit, to a serving node, assistance information for a configuration of measurement configuration information related to radio resource management (RRM), and receive, from the serving node, the measurement configuration information.

In one aspect, an embodiment of the present disclosure provides a serving node of a user equipment (UE) in a wireless communication system including a transceiver; and at least one processor coupled to the transceiver and configured to: receive, from the UE, assistance information for a configuration of measurement configuration information related to radio resource management (RRM), and transmit, to the UE, the measurement configuration information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic structure diagram of a wireless network system according to the present disclosure;

FIG. 2A illustrates a schematic diagram of a wireless transmission path according to the present disclosure;

FIG. 2B illustrates a schematic diagram of a wireless receiving path according to the present disclosure;

FIG. 3A illustrates a schematic structure diagram of an exemplary user equipment according to the present disclosure;

FIG. 3B illustrates a schematic structure diagram of an exemplary base station according to the present disclosure;

FIG. 4 illustrates a flowchart of a method executed by a user equipment in a wireless communication system according to an embodiment of the present disclosure;

FIG. 5 illustrates a flowchart of a communication method according to an embodiment of the present disclosure;

FIG. 6 illustrates a flowchart of another communication method according to an embodiment of the present disclosure; and

FIG. 7 illustrates a schematic structure diagram of an electronic device according to an embodiment of the present disclosure.

### DETAILED DESCRIPTION

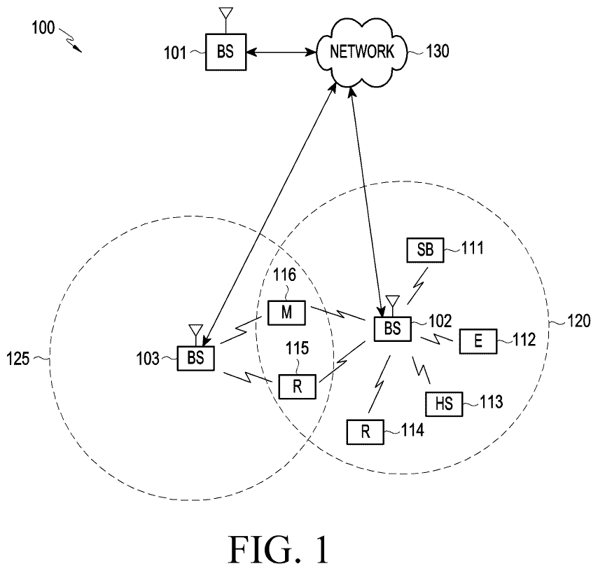

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those skilled in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. The gNB 101 communicates with gNB 102 and gNB 103. The gNB 101 also communicates with at least one Internet Protocol (IP) network 130, such as the Internet, a private IP network, or other data network.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user device” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a plurality of first User Equipments (UEs) within a coverage area 120 of gNB 102. The plurality of first UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to the network 130 for a plurality of second UEs within the coverage area 125 of the gNB 103. The plurality of second UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

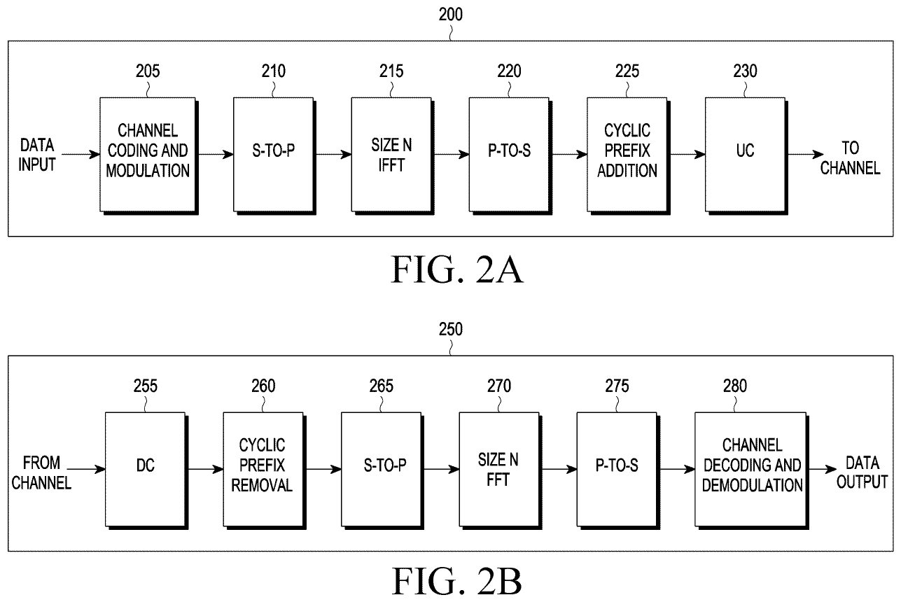

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

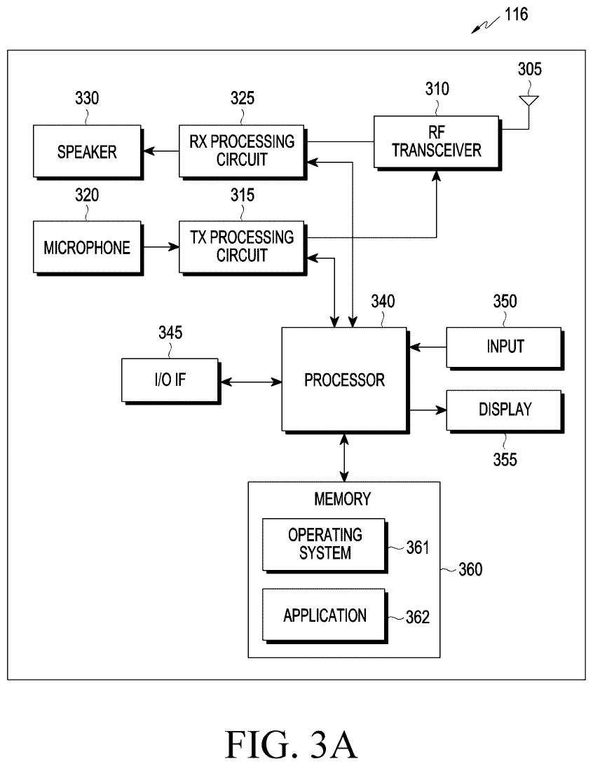

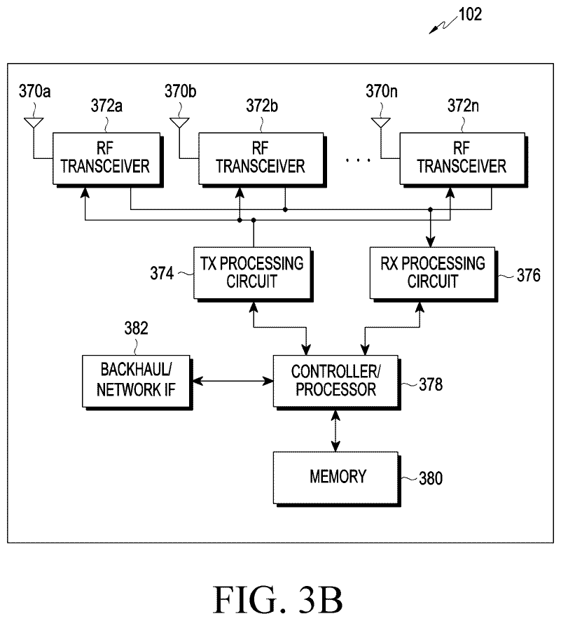

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface (IF) 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. Apart of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. Apart of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

With the development of 5G systems, in order to provide users with better communication services, for example, to provide communication services at any time and at any places, especially in scenes with coverage areas such as mountains, oceans and deserts, satellite communication systems have been introduced into 5G communication systems due to their advantages of larger communication distance and larger coverage area. Depending on the types and orbital altitudes of satellites, the satellite communication systems can be classified into synchronous orbit or geostationary earth orbit (GEO) satellite communication systems, and non-synchronous orbit or non-geostationary satellite communication systems. Further, depending on the orbital altitudes of satellites, the non-synchronous orbit satellite communication systems can be classified into medium earth orbit (MEO) (medium orbit for short) satellite communication systems and low earth orbit (LEO) (low orbit for short) satellite communication systems.

The embodiments of the present disclosure relate to a wireless communication method. This method can be applied to a scenario of executing a cell handover in a wireless communication system. The network in the embodiments of the present disclosure may be a terrestrial network or a non-terrestrial network.

In the embodiments of the present disclosure, the type of the cells of the network will not be limited. The cells of the network may include different types of cells of the network. For example, the cells may include, but not limited to, terrestrial network (TN) cells, non-terrestrial network (NTN) cells, macro cells, micro cells or the like. The cells of the UE before and after cell handover may be or may not be the same type of cells.

In the embodiments of the present disclosure, the user equipment (i.e., UE, also referred to as a terminal) may be configured with one or more antennas. The type of antennas configured in the UE will not be limited in the embodiments of the present disclosure, and may include, but not limited to, omni-directional antennas, parabolic antennas, phased array antennas or the like. When the UE is configured with more than one antenna, it may be configured with a plurality of antennas of the same type, or a plurality of antennas of different types, or antennas partially of the same type. According to the specific constituent architecture, different types of antennas or a plurality of antennas may have the same or different antenna capabilities, for example, which may include, but not limited to, antenna gain, beam width or the like. When the antennas configured in the UE are non-omni-directional antennas, the alignment of antenna beams includes electronic scanning, mechanical scanning or other steering scanning modes, wherein the electronic scanning may be configuring the phase of antenna oscillators or other modes, and mechanical scanning may be mechanically rotating the orientation of antennas or other modes.

In a wireless communication system, when the UE is in a connected state (RRC_CONNECTED), the network may realize the mobility management of the UE through a handover process, that is, the UE in the connected state may be switched from one cell to another cell thorough a cell handover or cell conditional handover process. This is because the movement of the UE or the movement of network coverage will lead to the constant change of the channel condition around the UE. In order to support the mobility management of the UE and timely obtain the channel condition of current surrounding cells of the UE, a network node will send the configuration information of radio resource management to the UE to configure the UE to perform RRM measurement, the UE in the connected state will report an RRM measurement result to the network node to assist the network to make a handover decision.

How to enhance the configuration of measurement configuration information of the UE to better satisfy the communication requires is one of the important issues that are studied all the time by relevant personnel in the communication field.

The method provided in the embodiments of the present disclosure may be executed by any electronic device/node. For example, this node may be a UE in a wireless communication system or may be a network node, where the network node may be a satellite, or may be a base station or other network nodes.

It is to be noted that, some term names involved in the embodiments of the present disclosure may adopt the term names that already exist in the communication standards, while some term names may be newly added or defined term names. These newly added or defined term names may also adopt other names in future communication standards, or may be described in other ways (e.g., a paragraph of text description). The names or appellations of various information/messages/parameters/configurations involved in the embodiments of the present disclosure are not unique, and the names or appellations of these information/messages/parameters/configurations can be altered as long as the functions or contents of these information/messages/parameters/configurations or the explanations or descriptions of these information/messages/parameters/configurations can be corresponding or associated. For example, in the embodiments of the present disclosure, the first information is information related to the type of the UE, and the first information may be replaced with the included information or other names. For example, the first information may also be referred to as UE type information.

The technical solutions provided by the present disclosure and the technical effects achieved by the technical solutions will be described below by various optional implementations. The following implementations can be referred to, learned from or combined with each other if not conflicted or contradicted, and the same terms, similar characteristics, similar implementation steps or the like in different implementations will not be repeated. For the interaction steps between different devices, based on the description of the solution for the device on one side, the corresponding solution for the device on the other side can be obtained. For example, the user equipment receives information; and correspondingly, the network node sends the information. In an embodiment including a plurality of steps, if there is no clear chronological order for the plurality of steps, the implementation order of the plurality of steps will not be uniquely defined in the embodiment of the present disclosure.

The optional implementations of the method provided by the present disclosure will be further described below with reference to the principle of the solutions provided by the present disclosure and several optional embodiments, and the steps in different embodiments can be combined or replaced with each other if not conflicted.

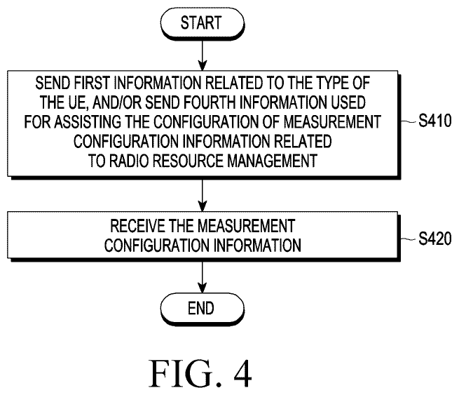

FIG. 4 illustrates a method executed by a UE in a wireless communication system according to an embodiment of the present disclosure. As shown in FIG. 4, this method may include the following steps.

In step S410, first information related to the type of the UE is sent, and/or fourth information used for assisting the configuration of measurement configuration information related to radio resource management is sent.

In step S420, the measurement configuration information is received, the measurement configuration information being configured based on the first information and/or the fourth information.

In the embodiment of the present disclosure, in order to configure the UE with more suitable measurement configuration information related to RRM, i.e., to enhance the configuration of measurement configuration information of the UE to better support the mobility management of the UE, before a serving node of the UE sends RRM configuration information to the UE, the UE may send first information (also referred to as auxiliary information, measurement configuration auxiliary information, etc.) to the serving node to assist the network to provide the UE with more suitable measurement configuration information, so that the UE can perform more efficient measurement based on the measurement configuration information, thereby providing the basis for improvement of cell handover efficiency and better satisfying the wireless communication requirements.

A node (the serving node of the UE, or a neighboring node of the serving node) may be a satellite or a base station; and correspondingly, the serving node of the UE may be a serving satellite, or a base station corresponding to the cell where the UE is currently located. When the node is a satellite, for the UE, the satellite may also be a satellite base station.

In the embodiment of the present disclosure, when the UE sends the information for assisting configuration to the serving node, it is possible that the UE actively reports the first information to the serving node, and it is also possible that the UE reports the related fourth information based on the indication or configuration of the serving node to assist the network to perform measurement configuration.

As an alternative, when in the connected state, the UE may actively report the first information related to the type of the UE to the serving node, and the serving node may provide the UE with the corresponding measurement configuration information according to the type of the UE based on this information. The first information reported to the serving node by the UE may be the explicit information of the type of the UE, for example, the type identifier (i.e., type ID) of the UE, or may be the implicit indication information of the type of the UE. The UE may determine the type of the UE according to the implicit indication information. For example, the type of the UE is determined according to the implicit indication information and a UE type classification principle. Optionally, the first information may include a UE type identifier.

The classification mode for the type of the UE will not be limited in the embodiment of the present disclosure. Optionally, the type of the UE is related to at least one of the following:
antenna configuration information of the UE; UE capability information; power class information of the UE; and, antenna capability information of the UE.

The antenna configuration information of the UE may also be called the antenna constituent architecture information of the UE. This information may include one or more of the information related to the antenna configuration of the UE, which may include, but not limited to, the type of antennas, the number of antennas, the alignment mode of antenna beams (electronic scanning or mechanical scanning, or whether to require mechanical scanning, etc.), the tracking speed for mechanical scanning and adjustment of antennas or the range of the tracking speed, antenna gain, antenna beam width, whether a circuit switching is required among a plurality of antennas, or the like. The tracking speed represents the speed of antenna adjustment, and may have a unit of radian/second, angle/second or other convertible units, such as radian/millisecond or angle/millisecond.

The UE capability information is the function information of the UE. For UEs with different capabilities, the measurement of the UE may be more efficient by configuring different measurement configuration information. Optionally, UEs may be classified into a plurality of different types according to the capability information of UEs. Upon receiving the UE type reported by the UE, the network node may send the measurement configuration information associated with this type to the UE. The UE capability information may include, but not limited to, one or more of the information related to the UE's capability defined in the existing communication systems. Optionally, the antenna configuration information of the UE, the power class information of the UE and the antenna capability information of the UE may be information independent of or included in the UE capability information. For another example, the UE capability information may also include the operating frequency range of the UE. The specific classification range for the operating frequency range of the UE will not be limited in the embodiment of the present disclosure, and may adopt the existing operating frequency range classification modes. For example, the UE may be a FR1 (frequency range 1) UE or a FR2 UE. The operating frequency range of the UE may also adopt a newly defined operating frequency classification mode. For example, the power frequency range may also be classified into at least two frequency ranges such as a range A and a range B, and the specific values of the upper frequency limit and lower frequency limit of each frequency range will not be limited. One or some of ranges in the newly defined operating frequency range may be the same as or different from the existing operating frequency ranges.

The power class information of the UE refers to the power class supported by the UE. The representation of the power class of the UE will not be limited in the embodiment of the present disclosure. For example, the power class of the UE may be related to the maximum output power, the transmission power or the like of the UE.

The antenna capability information of the UE may represent the antenna configuration or constituent architecture of the UE. This information may include one or more UE antenna information, for example, which may include, but not limited to, antenna gain, beam width or other information of the UE.

Optionally, the type of the UE may be classified according to one or of the above information related to the type of the UE. The UE may report the explicit or implicit indication of the type to the serving node.

As an alternative, Table 1 and Table 2 show two possible examples of UE classification based on the antenna configuration/architecture of the UE according to an embodiment of the present disclosure. In the two examples, the classification of UE type is mainly performed based on the combination of one or more of the type of antennas, whether antenna alignment requires mechanical scanning, the number of antennas, whether a circuit switching is required between antennas, the adjustment parameter (e.g., antenna tracking speed, etc.) used by the UE to adjust antennas during mechanical scanning alignment and other information.

In practical applications, it is possible to include all, or only some, or a combination of the items in the table. In the example of Table 2, optionally, according to whether the beam alignment of beams requires mechanical scanning, UEs may be classified into two types, i.e., a type requiring mechanism scanning, and a type not requiring scanning. Optionally, the UEs that require mechanical scanning for alignment may also be further classified according to the tracking speed for mechanical scanning and adjustment of antennas. In other words, the classification of UE types may be classification relative to coarse granularity, for example, UEs that require mechanical scanning for alignment are used as a UE type, while UEs that do not require mechanical scanning for alignment are used as another UE type; and, may also be classification relative to fine granularity, for examples, UEs may be classified into three UE types shown in Table 2. The specific classification mode for the range of the tracking speed in Table 1 may be set according to actual needs, and the classification of the range may include, but not limited to, a first range and a second range shown in Table 2, and may support more than or equal to one range. The specific range values of each range will not be limited in the embodiment of the present disclosure. For example, in some embodiments, the first range is greater than 90°/second, the second range is greater than 30°/second, and so on. The above numerical values are only examples for explaining their meanings, and should not be construed as unique limitations to the solution.

TABLE 1

| UE type | UE antenna configuration architecture |
|---|---|
| 1 | UEs that use omni-directional antennas and do not need |
| | to mechanically scan and adjust antennas for alignment |
| 2 | UEs that use phased array antennas and do not need to |
| | mechanically scan and adjust antennas for alignment |
| 3 | UEs that use a single phased array and/or parabolic |
| | antenna and need to mechanically scan and adjust |
| | antennas for alignment |
| 4 | UEs that use a plurality of phased array and/or parabolic |
| | antennas, need to perform a circuit switching between |
| | antennas and need to mechanically scan and adjust |
| | antennas for alignment |
| 5 | UEs that use a plurality of phased array and/or parabolic |
| | antennas, do not need to perform a circuit switching |
| | between antennas and need to mechanically scan and |
| | adjust antennas for alignment |
| 6 | UEs that use a plurality of phased array and/or parabolic |
| | antennas, do not need to perform a circuit switching |
| | between antennas and do not need to mechanically scan |
| | and adjust at least one antenna for alignment |

TABLE 2

| UE type | UE antenna configuration |
|---|---|
| 1 | UEs that need to mechanically scan and adjust antennas |
| | for alignment, where the tracking speed for mechanical |
| | scanning and adjustment of antennas is within the first |
| | range |
| 2 | UEs that need to mechanically scan and adjust antennas |
| | for alignment, where the tracking speed for mechanical |
| | scanning and adjustment of antennas is within the second |
| | range |
| 3 | UEs that do not need to mechanically scan and adjust |
| | antennas for alignment |

Optionally, the specific classification mode for UE types, for example, the classification mode shown in Table 1 or Table 2, may be stipulated in advance in the communication system, or may be configured to users by the network side.

For the convenience of description, the classification of UE types will be described by taking the example in Table 1 and/or Table 2 as an example.

In the embodiment of the present disclosure, when the UE sends the information related to the type of the UE to the serving node, it is possible to send the type identifier of the UE to the serving node (for example, the first message may directly include the UE type), or it is also possible to send one or more of the above information related to the type of the UE to the network node. The specific implementation of sending, by the UE, the first information to the serving node will not be limited in the embodiment of the present disclosure. Optionally, the first information may be carried in the UE capability information (UEcapabilitylnformation), or may also be carried in the existing or newly defined message in the communication system.

For different UE types, the serving node of the UE may provide different measurement configuration information. For example, different measurement events may be configured. Optionally, different cell handover procedures may also be used, and the network node may also expect the UE's behavior according to the type of the UE. For example, different UE types may correspond to different expected behaviors of the UE. Optionally, the handover delay requirement may also be different according to different UE types.

As an alternative, the handover measurement mode and/or handover delay requirement according to the type of the UE may be explicitly or implicitly stipulated. For example, the system stipulation or the network node indicates the UE what types of UEs can adopt an ordinary cell handover procedure and what types of UEs can adopt a cell conditional handover procedure.

In the embodiment of the present disclosure, the UE may also send the fourth information used for assisting measurement configuration to the serving node. The specific content included in the fourth information may be stipulated in advance, or may be sent by the UE based on the related indication or configuration information sent by the serving node.

As another optional embodiment of the present disclosure, this method may further include: receiving second information, the second information including information related to the fourth information to be sent by the UE. That is, the fourth information reported by the UE may be determined based on the second information.

In this embodiment, the UE may first receive the second information sent by the serving node and then report, based on the second information, the fourth information used for assisting the configuration of measurement configuration information. Optionally, the fourth information is sent after the second information is received (denoted by option A); or the second information is received periodically, and the fourth information is sent periodically (denoted by option B).

Optionally, for the option A, the UE may first actively report the information related to the type to the serving mode. After the serving node receives the first information (the information related to the type of the UE) reported by the UE and if the auxiliary information of higher level or capability is required for measurement configuration, the serving node may send the second information to the UE, so that the UE reports, to the serving node, more information for assisting measurement information. Optionally, if the serving node considers that the first node reported by the UE is already enough, it is unnecessary for the UE to report more auxiliary information. In this case, the serving node may not send the second information to the UE. In this option, after sending the first information, the UE may or may not receive the second information sent by the serving node. If the UE receives the second information, the UE needs to report more information (i.e., the fourth information) to the serving node based on the second information. Optionally, the UE may not report the first information to the serving node, and will report the fourth information to the serving node only when the second information sent by the serving node is received.

Optionally, for the option B, upon receiving the second information, the UE may determine whether to report the fourth information according to its own type. For example, if the UE is a first type of UE, the UE may not need to report the fourth information; and, if the UE is a second type of UE, the UE needs to report the fourth information. Or, the second information may carry a reporting condition, and the UE may determine whether to report the fourth information according to the reporting condition. For example, the reporting condition is that the second type of UEs needs to perform reporting. If the UE is the first type of UEs, the UE may not perform reporting.

In the embodiment of the present disclosure, the way of sending the second information by the serving node will not be limited, and the second information may be carried in the existing message/signaling or may be carried in the newly defined message/signaling. The serving node may send the second information by broadcasting or in other ways.

Optionally, the second information may be send based on a first condition, or may not be sent. The specific content of the first condition will not be uniquely limited in the embodiment of the present disclosure. As an alternative, the first condition may include: the second information is not sent when the type of the UE is the first type, and the second information is sent when the type of the UE is the second type. The first type and the second type are different types.

The specific way of the first type and the second type will not be limited in the embodiment of the present disclosure. For example, in some embodiments, the first type of UEs includes at least one of the following: UE type 1 or 2 or 6 in Table 1 or UE type 3 in Table 2.

Optionally, the second type of UEs includes at least one of the following: UE type 3 or 4 or 5 in Table 1 or UE type 1 or 2 in Table 2.

Optionally, the first type of UEs may indicate that the network uses the conventional technology to perform measurement configuration, and the second type of UEs indicates that the network needs the auxiliary information of higher level or capability to perform measurement configuration. Upon receiving the first information sent by the UE, the serving node may know according to the first information that the UE type is the first type or the second type, and may then determine whether to require the UE to provide more auxiliary information and whether to send the second information to the UE. If the serving node determines that the UE is the first type of UE, the second information is not sent; and, if the serving node determines that the UE is the second type of UE, the second information is sent.

Optionally, for the above option B, the UE may not actively report the first information to the serving node, but reports the fourth information based on the second information upon receiving the second information sent by the serving node. In this option, the information used for assisting measurement configuration reported to the serving node by the UE may only be the fourth information.

The specific content included in the second information may be determined by the serving node. For example, according to the actual network condition (e.g., the network resource condition, the network channel condition, etc.), the serving node may allow the UE to report some information to be referred for measurement configuration, thereby better providing more suitable measurement configuration information for the UE and better realizing the mobility management of the UE. Optionally, the fourth information reported by the UE may be or may not be related to the second information sent on the network side.

Optionally, the second information may include at least one of the following: information related to at least one beam of the serving node of the UE; and information related to at least one beam of at least one neighboring node of the serving node.

Optionally, the information related to a beam may include: at least one of the position information of the beam, the pointing direction of the beam, the width of the beam, and the angle range of the beam.

In the embodiment of the present disclosure, the communication network where the UE is located may be a terrestrial network or a non-terrestrial network. Optionally, when the node is a base station, the position information of the beam of the node may be construed as the position of the base station, or may be the reference location of the base station or the reference location of the beam of the base station; and, when the node is a satellite, the position information of the beam of the node may be construed as the reference location of the beam of the satellite. In a cell handover scenario, the types of nodes corresponding to the UE before and after handover may be the same or different. For example, both the serving node and the neighboring node are satellites; or, the serving node is a satellite, and the neighboring node is a base station.

In an optional embodiment of the present disclosure, this method may further include: receiving third information, the third information being used for requesting information to be reported by the UE.

The third information is the information that the serving node requests the UE to report. If the UE receives the third information sent by the serving node, the UE may report the corresponding information to the serving node according to the request/indication in the third information. In other words, the fourth information at least includes the information that the serving node instructs the UE to report. Optionally, the fourth information may also include other information that the UE wants or needs to report, for example, stipulated information to be reported. The specific information that the serving node instructs the UE to report will not be limited in the embodiment of the present disclosure.

Since the RRM measurement is used to assist the cell handover, before providing the measurement configuration to the UE, the serving node may send the related information of at least one beam of its related node (e.g., the current serving node, or at least one neighboring node of the serving node) to the UE; and, the UE may report, based on the information sent by the serving node, the information related to at least some of these beams to assist the measurement configuration.

In the embodiment of the present disclosure, the second information may be or may not be related to the third information, and the serving node may send at least one of the second information and the third information to the UE. In a case where the serving node sends the second information and the third information to the UE, the second information and the third information may be or may not be sent simultaneously, and the second information and the third information may be carried and sent in the same message or may be carried and sent in different messages. For example, the serving node requires the UE to report the position relationship (e.g., relative position relationship) between the UE and the serving node, and/or, the serving node requires the UE to report the position relationship between the UE and at least one neighboring node of the serving node. The serving node may provide, in the second information, the beam information of at least one beam of the serving node and/or the beam information of at least one beam of at least one neighboring node to the UE, and requests, in the third information, the UE to report the relative position relationship between at least one node (the serving node and/or neighboring node) and the UE. Upon receiving the second information and the third information sent by the serving node, the UE may report the relative position relationship between at least one beam of at least one node associated in the second information and the UE to the serving node.

Optionally, if the UE receives the second information and/or the third information after sending the first information or receives the second information and/or the third information periodically sent by the serving node, the UE shall report the fourth information to the serving node according to the received information. Optionally, if the third information is received, the corresponding content may be reported to the serving node according to the content expected to be reported by the UE in the third information. If the third information is not received, the UE may provide the fourth information to the serving node in a stipulated manner based on the content in the second information.

In the embodiment of the present disclosure, at least one of the first information, the second information, the third information and the fourth information may be configured to the UE by using a physical layer signaling, an MAC layer signaling or a high-layer signaling.

Optionally, the fourth information reported by the UE may include at least one of the following: information related to the position of the UE; the beam pointing direction of the UE when sending the fourth information; an adjustment parameter used by the UE to mechanically scan and adjust antennas.

Optionally, the adjustment parameter includes at least one of the following: tracking speed, angle adjustment range, and angle adjustment accuracy.

The information related to the position of the UE may be used to determine the relative position relationship (e.g., distance) between the UE and the serving node (e.g., the base station)/the beam of the serving node, and the information may assist the serving node to configure more measurement objects, measurement events or other measurement configuration information. Optionally, the information related to the position of the UE includes at least one of the following: position information of the UE; and, relative position information of the UE and at least one beam, the at least one beam including at least one beam in at least one of the following: at least one beam of the serving node of the UE; and at least one beam of at least one neighboring node of the serving node.

That is, the relative position information reported to the serving node by the UE may be the relative position relationship between the UE and one or more beams of the serving node, or may be the relative position relationship between the UE and one or more beams of the neighboring node, or may the relative position relationship between the UE and one or more beams of the serving node and the relative position relationship between the UE and one or more beams of the neighboring node.

In the embodiment of the present disclosure, when the UE reports the information related to the position of the UE to the serving node, the UE may report the position information of the UE (for example, when it is granted by the user) or may report the relative position information between the UE and the node/the beam of the node. For example, according to its own position and the reference location of the beam of the serving satellite in the received second information, the UE may calculate and report the relative position relationship between the UE and this beam; and, according to its own position and the reference location of the beam of the neighboring node of the serving node in the second information, the UE may calculate and report the relative position relationship between the UE and this beam.

Optionally, the UE may report the relative position relationship between the UE and each beam in the received second information, or may also report the relative position relationship between the UE and some beams in the second information. For example, the relative position relationship corresponding to a number of beams at a smaller distance from the UE may be reported according to the relative position relationship, or the relative position relationship corresponding to some or all of the beams may be reported according to other stipulated rules.

The pointing direction of the beam of the UE when sending the fourth information refers to the beam pointing direction of the UE when the UE reports the fourth information to the serving node. Based on this information, the serving node may know the azimuth information of the beam of the UE so as to provide more suitable measurement configuration information to the UE.

The adjustment parameter used by the UE to mechanically scan and adjust antennas is related to the beam alignment of the UE. When the UE performs alignment in a mechanical scanning manner, different antenna adjustment parameters will affect the efficiency of alignment, the accuracy of alignment or the like. Therefore, by providing this parameter to the serving node, the serving node can provide more suitable measurement configuration information according to the antenna characteristics of the UE.

In the embodiment of the present disclosure, the serving node may configure, to the UE, one or more of different measurement object, measurement time or system configuration information according to the information used for assisting measurement configuration reported by the UE. Optionally, the measurement configuration information sent to the UE by the network may include at least one measurement event, and the at least one measurement event may include at least one of the following first event, second event or third event: a distance-related first event, wherein the distance includes a first distance between the UE and a beam of the serving node and/or a second distance between the UE and a beam of at least one neighboring node of the serving node; an angle-related second event, wherein the angle includes at least one of a first angle, a second angle, a third angle and a fourth angle, the first angle is an angle when the UE is aligned with a beam of the serving node, the second angle is an angle when the UE is aligned with a beam of at least one neighboring node of the serving node, the third angle is an angle when the UE is aligned with the serving node, and the fourth angle is an angle when the UE is aligned with at least one neighboring node; and optionally, the first angle and/or the second angle may be the elevation angle after the UE mechanically scans and is aligned with the node and/or beam, and the third angle and/or the fourth angle may be the elevation angle of the UE when the UE is aligned with the node; and a time-related third event, optionally, the time includes a first time and/or a second time, wherein the first time is related to a fifth angle and a tracking speed used by the UE to mechanically scan and adjust antennas, the second time is related to the angle after the UE is aligned with the serving node and the tracking speed used by the UE to mechanically scan and adjust antennas, and the fifth angle is an included angle between the pointing direction of a beam of the serving node and the pointing direction of a beam of at least one neighboring node of the serving node.

Optionally, the first time is equal to the ratio of the fifth angle to the tracking speed. The first time may also be called adjustment time or antenna adjustment time, and may be construed as the adjustment time required by the UE to adjust from alignment with the beam of the serving node to alignment with the beam of the neighboring node. Optionally, the second time is equal to the ratio of the angle after the UE is aligned with the serving node to the tracking speed. Optionally, the second time may be called visible time or observable/detectable time, and may be construed as the time used by the UE from a situation where the UE is aligned with the serving satellite to a situation where the UE cannot observe the serving satellite.

The first event, the second event and the third event are three new measurement events proposed in the embodiment of the present disclosure, and for the received measurement event, the UE may determine whether to report the measurement report according to the result of comparison of the corresponding parameter (distance, angle, time, etc.) with the threshold corresponding to this parameter. Each event corresponds to a respective entering condition (also referred to as a trigger condition) and a leaving condition (also referred to as a cancellation condition). For any measurement event, the definitions/explanations of the entering condition and the leaving condition may refer to the definitions/explanations of the access condition and the leaving condition in the conventional technology. For example, in the event trigger based reporting mode, the UE triggers the sending of the measurement report only when the measurement event entering threshold configured by the network is satisfied and lasts for a period of event. The entering condition and leaving condition corresponding to one measurement event may be associated with the result of comparison of the parameter corresponding to this event with the threshold.

In an optional embodiment of the present disclosure, the entering condition for the first event (also referred to the first measurement event) may include: the different between the first distance and a first offset is greater than or equal to a first threshold, and/or the sum of the second distance and a second offset is less than or equal to a second threshold.

Optionally, the leaving condition for the first event may include: the sum of the first distance and the first offset is less than or equal to the first threshold, and/or the difference between the second distance and the second offset is greater than or equal to the second threshold.

By taking both the serving node and the neighboring node are satellites, the entering condition for the first event may include: the result of the distance (the first distance) between the UE and the reference location of the beam of the serving satellite minus the first offset (also referred to as a lag offset) is greater than or equal to the threshold 1 (the first threshold), and/or the result of the distance (the second distance) between the UE and the reference location of the beam of the neighboring satellite of the serving satellite plus the second offset is less than or equal to the threshold 2 (the second threshold); and, the leaving condition for the first event may include: the result of the distance between the UE and the reference location of the beam of the serving satellite plus the offset is less than or equal to the threshold 1, and/or the result of the distance between the UE and the reference location of the beam of the neighboring satellite of the serving satellite minus the second offset is greater than or equal to the threshold 2.

Optionally, for the second event, the entering condition may include at least one of the following: the difference between the first angle and a third offset is less than or equal to a third threshold, the result of the second angle plus the third offset is greater than or equal to a fourth threshold, the difference between the third angle and a fifth offset is less than or equal to a fifth threshold, and the sum of the fourth angle and the sixth offset is greater than or equal to a sixth threshold.

Optionally, the leaving condition for the second event may include at least one of the following: the sum of the first angle and the third offset is greater than or equal to the third threshold, the difference between the second angle and the fourth offset is less than or equal to the fourth threshold, the sum of the third angle and the fifth offset is greater than or equal to the fifth threshold, and the sum of the fourth angle and the sixth offset is less than or equal to the sixth threshold.

Optionally, for the third event, the entering condition may include: the difference between the first time and a seventh offset is less than or equal to a seventh threshold, and/or the difference between the second time and an eighth offset is less than or equal to an eighth threshold.

Optionally, the leaving condition for the third event may include: the sum of the first time and the seventh offset is greater than or equal to the seventh threshold, and/or the sum of the second time and the eighth offset is greater than or equal to the eighth threshold.

The thresholds (e.g., the first threshold and second threshold corresponding to the first event) corresponding to each event may be sent to the UE by the serving node. For example, the measurement configuration information includes the measurement events and the thresholds corresponding to the events. The offsets corresponding to different objects of the same parameter (e.g., the first distance and the second distance, the first angle and the second angle, and the first time and the second time) may be the same or different. For example, the first threshold and the second threshold may be the same, while the third threshold and the fourth threshold may be different.

Optionally, in order to avoid the situation the link between the UE and the serving satellite is interrupted since the UE is already not within the coverage range of the serving satellite when the UE is aligned with the serving node by mechanical scanning after it is aligned with the neighboring node of the serving node for measurement by mechanical scanning, the first threshold corresponding to the first distance is not greater than a first value, wherein the first value may be related to at least one of the following: ephemeris information of the serving node and/or neighboring node; the pointing direction of a beam of the serving node and/or neighboring node; the angle range of a beam of the serving node and/or neighboring node; the beam pointing direction of the UE when sending the fourth information; the tracking speed at which the UE mechanically scans antennas; the moving speed or preset speed of a satellite; and an angle tolerance range.

Optionally, at least one measurement event configured for the UE by the serving node may be configured based on the type of the UE. In other words, different types of UEs may correspond to different measurement events. For example, if the UE belongs to the first type of UEs, the measurement event may include the first event; and, if the UE belongs to the second type of UEs, the measurement event may include the second event and/or the third event.

In the embodiment of the present disclosure, this method further includes: sending/reporting a measurement report based on the measurement configuration information; executing a cell handover process when a cell handover command is received.

Different UEs may also correspond to different cell handover delays. Optionally, the handover delay used for the cell handover of the UE may include at least one of the following: a third time, and a target cell search time; wherein the third time includes at least one of a fourth time and a fifth time, the fourth time is an antenna adjustment time required by the UE in the handover process, and the fifth time is a time required for a circuit switching between different antennas of the UE; and the target cell search time is related to the type of the UE.

In the embodiment of the present disclosure, the cell handover may be an ordinary cell handover, or may be based on a cell conditional handover. For different UEs, since the beam alignment modes for UEs are different, for the UEs that realize beam alignment by mechanical scanning, the UEs need to take time for antenna adjustment during the cell handover; and, if a UE is configured with a plurality of antennas and if UE needs to perform a circuit switching between antennas, it also takes time for the circuit switching. On this basis, in the embodiment of the present disclosure, the cell handover delay of the UE may include a third time, and the third time may include the antenna adjustment time required by the UE in the handover process and the time required by the UE to perform a circuit switching between different antennas. The antenna adjustment time and the time required for the circuit switching may be or may not be 0.

The target cell search time is the time required by the UE to search a target cell during the cell handover. If the UE receives a handover command and if the target cell is unknown, the target cell search time is required; and, if the target cell is known, the target cell search time may be 0. In the current related art, the target cell search time for a UE generally only depends on the type of the target cell (for example, the target cell is an unknown intra-frequency cell or an unknown inter-frequency cell), so that the target cell search times for some UEs are too long. In an optional solution provided in the embodiment of the present disclosure, the target cell search time for the UE in the handover process may be associated with the type of the UE, and different types of UEs may correspond to different target cell search times. Optionally, the target cell search time corresponding to the UE may be related to the type of the UE and/or the type of the target cell. By using this solution provided in the embodiment of the present disclosure, the target cell search times for some types of UEs can be effectively reduced, the handover time can be saved, and the system efficiency can be improved.

It should be understood that, in practical applications, when the UE performs a cell handover or a cell conditional handover, in addition to the third time and/or the target cell search time, the handover delay requirement should also include other essential handover or conditional handover delay parameters, such as interruption time and measurement time. Each time involved in the handover or conditional handover delay requirement may also be called a delay.

Based on the solution provided in the embodiment of the present disclosure, the serving node (e.g., a base station or a satellite base station) configures suitable measurement configuration information according to the unique characteristics of the UE. For example, it may configure different measurement objects and measurement events and/or different system configuration information according to the characteristics of the UE. Thus, invalid measurements can be reduced, more useful reference information can be provided for subsequent cell handover decision, and the handover efficiency can be improved.

In order to better understand and describe the solution provided in the present disclosure, the optional embodiments provided in the present disclosure will be described below by taking the node being a satellite as an example.

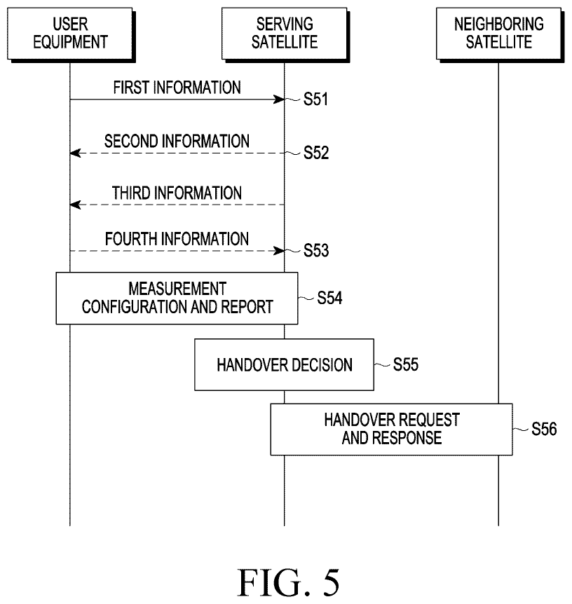

FIG. 5 illustrates a flowchart of an enhanced cell handover method based on the solution provided in the present disclosure. As shown in FIG. 5, the communication method in this embodiment may include the following steps.

In step S51, a user equipment in a connected state reports first information.

In this step, the UE sends the first information related to the type of the UE to a serving satellite, i.e., a serving node. Optionally, the first information may include the above UE type. Optionally, the classification of UE types may adopt, but not limited to, the classification mode in the above Table 1 or Table 2. The UE may determine its type according to its own information and the classification rule for UE types, and send the type to the serving satellite. Optionally, the first information may be carried in the UEcapabilityInformation, or may be carried in a newly defined message.

In step S52, when the serving satellite receives the first information, the serving satellite may send or not send second information and/or third information to the UE.

Optionally, the serving satellite may determine to send or not send the second information and/or the third information according to a first condition. The first condition may be related to the UE type, and the serving satellite may determine whether to send the second information and/or the third information according to the UE type (the first information related to the type of the UE) reported by the UE and the first condition. Optionally, the first condition may include, but not limited to: for a first type of UEs (e.g., Type A), the serving satellite does not send the second information and/or the third information; and, or a second type of UEs (e.g., Type B), the serving satellite sends the second information and/or the third information.

In the present disclosure, the classification mode for the first type of UEs and the second type of UEs will not be limited. Optionally, the first type of UEs may be any type in Table 1 or Table 2, or the first type includes a plurality of types in Table 1 or Table 2; and, the second type of UEs may also be one type or include a plurality of UE types. When the first type of UEs includes a plurality of types and only if the type of a user equipment belongs to any one of the plurality of types, this user equipment belongs to the first type of UEs.

Optionally, the type classification of the first UE type and the second UE type in the first condition may be same as or different from the classification mode for UE types reported to the serving satellite by the UE. Optionally, the UE type reported by the UE may be classified from the perspective of the UE, and the first UE type and the second UE type in the first condition may be classified from the perspective of the network node. For example, the first type of UEs indicates that the network performs measurement configuration by using the conventional technology, and the second type of UEs indicates that the network needs the auxiliary information of higher level or capability to perform measurement configuration. The first type of UEs includes at least one UE type (classified from the perspective of the UE), and the second type of UEs includes at least one UE type. Upon receiving the UE type reported by the UE, the serving mode may determine according to the UE type whether the UE belongs to the first type of UEs or the second type of UEs; if it is determined that the UE belongs to the second type of UEs, the serving node may send the second information and/or the third information to the UE; and, if it is determined that the UE belongs to the first type of UEs, the serving node may not send the second information and/or the third information.

In the embodiment of the present disclosure, the second information and the third information may correspond to different conditions. For example, the serving satellite may determine whether to send the second information according to the condition 1 and determine whether to send the third information according to the condition 2. Or, the second information and the third information may correspond to the same condition, and the second information and the third information are sent or not sent simultaneously. For example, the condition 1 may be the type of the UE, and the condition 2 may be other capability information of the UE, the type or load condition of the serving node or the like. For example, the condition corresponding to the second information is the above first condition; and, the third information is sent when the second information is sent, or is not sent when the second information is not sent.

Optionally, the third information is used to request the fourth information reported by the UE, that is, the serving node configures/requests, to the UE, which information should be included in the fourth information reported by the UE.

Optionally, the second information may include the related information of at least one beam (e.g., the beam of the serving satellite where the UE is currently located, at least one neighboring satellite of the serving satellite (the candidate target satellite corresponding to the cell handover)) related to the cell handover of the UE.

Optionally, the second information includes at least one of the following: a reference location set of N1 (N1>1) beams of the serving satellite (or the serving satellite cell or the serving cell) (N1 is greater than or equal to 1), the beam pointing direction and/or angle range of N1 beams of the serving satellite, a neighboring satellite cell list including at least one neighboring satellite (or a beam list of the neighboring satellite, or a beam list of the neighboring satellite cell).

The neighboring satellite cell list includes the reference location set of at least one beam. Optionally, the neighboring satellite cell list may include the beam information of at least one neighboring satellite cell. Any cell in this list may include the reference location set of N2 beams of this neighboring satellite cell (N2 is greater than or equal to 1) and the beam information of at least one beam among the N2 beams, for example, at least one of the beam pointing direction, angle range, beam width and other information of the beam. The beam pointing direction and the angle range may include at least one of the following: elevation angle, azimuth angle, and yaw angle. Optionally, according to the type of the satellite and/or the type of the beam, the reference location may or may not include time information because some satellites are static while some satellites are not static, and some beams are fixed beams while some beams are moving beams. For moving beams, the reference location needs to carry time information. Optionally, the pointing direction/angle range of the beam may be a relative pointing direction/angle range. For example, for a fixed beam, the beam pointing direction may be a fixed pointing angle relative to a base station direction/reference direction; while for a moving beam, the beam pointing direction may be a relatively fixed pointing angle of the beam at a certain moment. The angle range may be the corresponding beam angle when the beam power decreases by several dB (e.g., 3 dB) compared to beam pointing direction (maximum value), for example, the angle when the beam power decreases to half.

In the embodiment of the present disclosure, the beam information may include, but not limited to, the beam pointing direction, the angle range, the beam width or the like. For the UE, theoretically, the beam information may be any related information that enables the UE to determine the beam azimuth information to realize beam alignment or measurement.

In step S53, if the user equipment receives the second information and/or the third information, the user equipment may report fourth information.

Optionally, the fourth information includes at least one of the following:
position measurement reporting information (the position information of the UE, also referred to as the information related to the position of the UE), a beam pointing direction of the UE at a reporting moment (the beam pointing direction of the UE when sending the fourth information), a tracking speed at which the UE mechanically scans and adjusts antennas, and an angle adjustment range and/or adjustment accuracy at which the UE mechanically scans and adjusts antennas.

In one embodiment, the position measurement reporting information may be measured in the following way: the UE calculates the relative position relationship according to its own information and the reference location of the beam of the serving satellite or the reference location of the beam of the neighboring satellite cell in the received second information, and reports it in the fourth information. The UE may report the relative position relationship corresponding to some beams or all beams in the second information. For example, the serving satellite indicates, in the third information, the number of beams that UE needs to report information, the condition to be satisfied by the reported beam (for example, the distance between the beam and the UE is less than the set distance) or the like. According to the beam screening rule (which may be configured by the serving satellite or may be stipulated; for example, selecting a closer beam according to the distance between the UE and the reference location of the beam), the UE may report the corresponding number of beams or the corresponding relative position relationship satisfying the condition in the second information to the serving satellite.

If the serving satellite receives the fourth information, the serving satellite may perform a subsequent cell handover procedure based on the information reported by the UE, for example, the steps S54 to S56 shown in FIG. 5.

Step S54: a measurement configuration and a report are performed.

In this step, the serving satellite (source node) performs measurement configuration on the UE. For example, the serving satellite may perform RRM measurement configuration on the UE in an RRC process, i.e., providing measurement configuration information to the UE. The measurement configuration information may include: a measurement object, a reporting configuration, a measurement identifier, a measurement quantity configuration, a measurement start threshold, a measurement interval or other information. Upon receiving the measurement configuration, the UE may perform measurement according to the measurement configuration to obtain a measurement result, and then perform measurement reporting. For example, when the reporting condition is satisfied, the UE sends a measurement report to the serving node.

The way of sending, by the UE, the measurement report to the serving satellite may be measurement event-triggered reporting. For the event-triggered reporting mode, the UE will trigger the sending of the measurement report only when the measurement event satisfying the network configuration enters a threshold (threshold value) and lasts for a period of time. The reporting configuration corresponding to the event-triggered reporting may include measurement events and their threshold parameters.

In the solution provided in the embodiment of the present disclosure, the measurement events involved in the cell handover process may include, but not limited to, the measurement events defined in the existing standards. Optionally, the measurement event of the measurement configuration in the solution provided in the embodiment of the present disclosure may include at least one of the following.

The first measurement event is a distance-related measurement event. The UE may determine whether to perform reporting according to the result of comparison of the distance between the UE and the reference location of the beam of the serving satellite with a threshold 1 (first threshold) and/or the result of comparison of the distance between the UE and the reference location of the beam of the neighboring satellite with a threshold 2 (second threshold). The thresholds 1 and 2 are sent to the UE by the base station or the serving satellite. For the first type of UEs, the setting of the thresholds 1 and 2 does not consider the influence of the fourth information. For the second type of UEs, the setting of the thresholds 1 and 2 is determined by the fourth information and other conventional parameters. The first measurement event may be a measurement event suitable for the first type of UEs and/or the second type of UEs.

For different beams, at least one of the corresponding thresholds 1 or 2 may be the same or different. For beams of different nodes, beams of different cells or beams of different cells of the same node, the thresholds 1 and/or 2 corresponding to the beams may be the same or different.

In one optional embodiment, the threshold 1 configured for the UE by the serving satellite is not greater than a first value. Optionally, the serving satellite may calculate the maximum value of the threshold 1 according to the ephemeris information of the serving node and the neighboring node and/or the pointing direction and angle range of the beam. Optionally, the maximum value may be calculated by the following formula:

$$the radius of the serving satellite - \frac{angle α - \frac{angle range 1}{2} + angle β - \frac{angle range 2}{2} + tolerance rnage}{the tracking speed at which the UE mechanically scans antennas} * The moving speed of the satellite or the predefinedvalue$$

where the radius of the serving satellite refers to the radius of the serving area/coverage range of the serving satellite; optionally, the radius of the serving satellite may also be replaced with the radius of the serving cell; the angle α is equal to the included angle between the beam pointing direction of the UE at the reporting moment and the beam of the neighboring satellite; the angle β is equal to the included angle between the serving satellite and the neighboring satellite; the angle range 1 is equal to the angle range of the beam of the neighboring satellite; the angle range 2 is equal to the angle range of the serving satellite plus the angle range of the neighboring satellite; and the tolerance range may be the preset value or stipulated value.

In the embodiment of the present disclosure, the threshold 1 configured for the UE by the serving satellite should not be greater than the above maximum value; otherwise, when the UE that needs to mechanically scan and adjust antennas for alignment is aligned with the neighboring satellite by mechanical scanning for measurement and then aligned with the serving satellite by mechanical scanning, the UE may be already not within the coverage range of the serving satellite, and the link has been interrupted before the handover process is completed, so that an RRC connection reestablishment process is triggered and the network handover success rate and the network communication efficiency are reduced.

Optionally, the entering condition for the first measurement event may include: the difference between the first distance between the UE and the reference location of the beam of the serving satellite and the offset 1 is greater than or equal to the threshold 1, and/or the sum of the second distance between the UE and the reference location of the beam of the neighboring satellite and the offset 2 is less than or equal to the threshold 2. The leaving condition may include: the sum of the first distance and the offset 1 is less than or equal to the threshold 1, and/or the difference between the second distance and the offset 2 is greater than or equal to the threshold 2.

The first measurement event may be defined as a measurement event in which the difference between the first distance and the offset 1 is greater than or equal to the threshold 1 and/or the sum of the second distance and the offset 2 is less than or equal to the threshold 2.

In the embodiment of the present disclosure, the first information and/or the fourth information can effectively assist the base station or the serving satellite to determine suitable measurement configuration information for different UE types.

The second measurement event is an angle-related measurement event. Optionally, the second measurement event may be a measurement event suitable for the second type of UEs. For the second type of UEs, the UE may determine whether to perform reporting according to the result of comparison of the relative relationship after the UE is aligned with the serving satellite by mechanical scanning with a threshold 3 (third threshold or fifth threshold) and/or the result of comparison of the relative relationship after the UE is aligned with the neighboring satellite with a threshold 4 (fourth threshold or sixth threshold). Optionally, the relative relationship after the UE is aligned with the satellite may be the elevation angle (second angle or fourth angle) of the UE aligned with the satellite and/or the elevation angle (first angle or third angle) after aligned with the beam of the satellite. For example, for a serving satellite, the elevation angle may be the elevation angle 1 after the UE is aligned with the serving satellite and/or the beam of the serving satellite by mechanical scanning; while for a neighboring satellite, the elevation angle may be the elevation angle 2 after the UE is aligned with the neighboring node and/or the beam of the neighboring node. The elevation angle of the satellite is the included angle between the line of sight of an observer at a point on the earth to the satellite and the local horizon line at a given moment, and is generally used to describe the position where the satellite passes above the observer at a certain moment. In the embodiment of the present disclosure, the elevation angle may represent the included angle of the line of sight of the UE observing the satellite and the horizon line, and may represent the relative position relationship between the satellite and the UE, for example, the position of the UE where the satellite is located currently.

Optionally, the entering condition for the second measurement event may be that the result of the elevation angle 1 minus the lag offset (the different between the elevation angle and the lag offset) is less than or equal to a threshold 3, and/or the result of the elevation angle 2 plus the lag offset (the sum of the elevation angle 2 and the lag offset) is greater than or equal to a threshold 4, wherein the thresholds 3 and/or 4 are preset values that are sent to the UE by the base station or the serving satellite or determined according to the UE type. The leaving condition for the second measurement event may be that the result of the elevation angle 1 plus the lag offset is greater than or equal to the threshold 3, and/or the result of the elevation angle 2 minus the lag offset is less than or equal to the threshold 4. The value of the lag offset may be or may not be zero, and this value may be a stipulated value or may be configured for the UE by the serving satellite. The lag offset may also be directed called an offset, preset value or other names.

Optionally, the second measurement event may be defined as an event in which the difference between the elevation angle 1 and the offset 3 is less than or equal to the threshold 3 and/or the sum of the elevation angle 2 and the offset 4 is greater than or equal to the threshold 4. The elevation angle 1 may be the first angle and/or the third angle; the elevation angle 2 may be the third angle and/or the fourth angle; the offset 3 corresponding to the first angle is the third offset; the offset 4 corresponding to the second angle is the fourth offset; the offset 3 corresponding to the third angle is the fifth offset; and, the offset 4 corresponding to the fourth angle is the sixth offset.

The third measurement event is an event-related measurement event. Optionally, the third measurement event may be a measurement event suitable for the second type of UEs. For the second type of UEs, the UE determines whether to perform reporting according to the result of comparison of at least one of the following and the related threshold: the included angle between the pointing direction of a beam of the serving satellite and the pointing direction of a beam of the neighboring satellite; the elevation angle of the serving satellite; and, the tracking speed at which the UE mechanically scans and adjusts antennas.

For the entering condition for the third measurement event is that the difference between the first time and the lag offset (seventh offset) is less than or equal to a threshold 5 (seventh threshold) and/or the difference between the second time and the lag offset (eighth offset) is less than or equal to a threshold 6 (eighth threshold); and, the leaving condition for the third measurement event may be that the sum of the first time and the lag offset is greater than or equal to the threshold 6 and/or the sum of the second time and the lag offset is greater than or equal to the threshold 6. The thresholds 5 and/or 6 are preset values that are sent to the UE by the base station or the serving satellite or determined according to the UE type. The value of the lag offset may be or may not be zero.

$$the first time = \frac{The included angle between the pointing direction of a beam of the serving satellite and the pointing direction of a beam of the neighboring satellite}{The tracking speed at which UE mechanically scans and adjust anttennas} ; and$$

$$the second time = \frac{The elevation angle after the UE is aligned with the serving satellite}{The tracking speed at which the UE mechanically scans and adjusts antennas} .$$

Optionally, the third measurement event may be defined as an event in which the difference between the first time and the offset 5 is less than or equal to the threshold 5 and/or the difference between the second time and the offset 6 is less than or equal to the threshold 6.

In step S55, a handover decision is made.

Upon receiving the measurement report from the UE, the serving satellite may make a handover decision according to a handover algorithm with reference to the reporting result of the UE, to determine whether the UE needs to perform a cell handover, and a target satellite corresponding to the cell handover during handover.

In step S56, a handover request and a response are performed.

Optionally, the serving satellite sends a handover request message to the target satellite (the neighboring satellite in FIG. 5) and transmits related information necessary handover preparation to the target satellite, and the target satellite may perform admission control and handover preparation based on the received handover request message and then send a request response message to the serving satellite, wherein the handover command sent to the UE may be included in the response message. The serving satellite may send the handover command to the UE; and, upon receiving the handover command, the UE synchronizes with the target satellite and accesses the target satellite by using a random access process.

The handover delay requirement to be satisfied by the cell handover of the UE is that: when the UE receives an RRC message/command (handover command) to instruct the UE to perform a cell handover to a new cell, the UE shall be ready to start the transmission of a new uplink physical random access channel (PRACH) within D_{handover} ms from the end of the last transmission time interval (TTI) containing the RRC command.

In an optional embodiment of the present disclosure, D_{handover} is equal to the RRC procedure delay plus the interruption time plus the first time interval (third time), wherein the first time interval is used to describe the antenna adjustment time required by the UE in the handover process and the time required by the device to perform a circuit switching between different antennas. Optionally, the first time interval may be added within the interruption time, or may be newly added after the interruption time. That is, the first time interval may be included in the time included in the existing handover delay, or may be the newly added independent time. By adding this time interval, different time lengths may be set to adapt to different behaviors required by different types of UEs during handover, so that the overall handover efficiency of the communication system is improved.

One possible formula of the first time interval is described as:

$${T}_{antenna - adjust} = M * {T}_{rotation} + N * {T}_{switch} \qquad ( 1 )$$

where T_{antenna-adjust} is the newly added first time interval, describing the antenna adjustment time required in the handover process and the time required by the device to perform a circuit switching between different antennas; M is the number of mechanical scanning times required by antennas of the UE in the handover process; Tᵣₒₜₐₜᵢₒₙ is the time required for a single mechanical rotation of antennas of the UE in the handover process; N is the number of times that the UE performs circuit switching between antennas in the handover process; T_{switch} is the time required for a single circuit switching between antennas of the UE in the handover process; and M*Tᵣₒₜₐₜᵢₒₙ represents the antenna adjustment time required by the UE in the cell handover process, and N*T_{switch} represents the time required by the UE to perform a circuit switching between different antennas in the cell handover process.

The antenna adjustment time and/or the time required for the circuit switching may be or may not be 0 because some UEs may not require or may ignore the antenna adjustment time or circuit switching time. For example, a UE does not need to perform a circuit switching between different antennas; for another example, the alignment mode for antenna beams of a UE is electronic scanning, and the required time may be ignored.

According to the description of the UE classification types in the example of Table 1 and the formula in the above example, the mapping relationship corresponding to one possible antenna adjustment time interval (i.e., the first time interval) may be shown in Table 3 below:

TABLE 3

| UE type | Newly added time interval, e.g., T_{antenna-adjust} |
|---|---|
| 1 | T_{antenna-adjust} = 0 or M = 0, N = 0 or inapplicable |
| 2 | T_{antenna-adjust} = 0 or M = 0, N = 0 or inapplicable |
| 3 | T_{antenna-adjust} = 3*Tᵣₒₜₐₜᵢₒₙ or M = 3, N = 0 |
| 4 | T_{antenna-adjust} = 1*Tᵣₒₜₐₜᵢₒₙ + 3*T_{switch} or M = 1, N = 3 |
| 5 | T_{antenna-adjust} = 1*Tᵣₒₜₐₜᵢₒₙ or M = 1, N = 0 |
| 6 | T_{antenna-adjust} = 0 or M = 0, N = 0 |

By taking the UE type 1 as an example, this type of UEs are UEs that use omni-directional antennas and do not need to mechanically scan and adjust antennas for alignment. Thus, M may have a value of 0, and the first time interval may be 0; or, it can be understood that the first time interval is inapplicable for this type of UEs, that is, the first time interval may not be added for this type of UEs.

By taking the UE type 3 as an example again, this type of UEs are UEs that use a single phased array and/or parabolic antenna and need to mechanically scan and adjust antennas for alignment. This type of UEs needs to use mechanical scanning for antenna alignment; however, since there is a single antenna, there is no circuit switching between different antennas, so N=0, where the value of M may be a stipulated value, and the values of M corresponding to different types of UEs may be the same or different. For example, the value of M corresponding to a UE that is configured with a single antenna and needs to perform mechanical scanning is not less than that of a UE that is configured with a plurality of antennas and needs to perform mechanical scanning, or the value of M may also be related to the antenna adjustment speed of the UE. When other information is the same, the value of M corresponding to a UE with a higher tracking speed may be relatively smaller.

For the interruption time in the handover delay requirement, this time is the time between the end of the last TTI containing the RRC command on an old physical downlink shared channel (PDSCH) and the time the UE starts transmission of the new PRACH, excluding the RRC procedure delay. When the UE is commanded to perform a cell handover, the interruption time should be less than the time length Tᵢₙₜₑᵣᵣᵤₚₜ.

If the newly added time interval (i.e., the first time interval, e.g., the above T_{antenna-adjust}) describing the antenna adjustment time required in the handover process and/or the time required by the device to perform a circuit switching between different antennas is added in the interruption time, the interruption time may be described by the following equation (2):

$${T}_{interrupt} = {T}_{search} + {T}_{IU} + {T}_{processing} + {T}_{Δ} + {T}_{margin} + {T}_{antenna - adjust} \qquad ( 2 )$$

where T_{search} is the time required to search the target cell (for example, also referred to as first search time or target cell search time, etc.) when the UE receives the handover command (e.g., the above RRC message or command) and the target cell is unknown. If the target cell is known, T_{search}=0 mS.

Optionally, when the target cell is a cell in a frequency range 1 (FR1 for short): if the target cell is an unknown intra-frequency cell and the Es/Iot (the ratio of useful signals to interference and noise on a symbol) of the target cell is greater than or equal to a first threshold (dB), T_{search}=Tᵣₛ Ms; and, if the target cell is an unknown inter-frequency cell and the Es/Iot of the target cell is greater than or equal to the first threshold (dB), T_{search}=3*Tᵣₛ Ms.

Optionally, when the target cell is a cell in a frequency range 2 (FR2 for short) or other frequency ranges: if the target cell is an unknown intra-frequency cell and the Es/Iot of the target cell is greater than or equal to a second threshold (dB), T_{search}=N*Tᵣₛ Ms. If the target cell is an unknown inter-frequency cell and the Es/Iot of the target cell is greater than or equal to the second threshold (dB), T_{search}=3*N*Tᵣₛ Ms. In the embodiment of the present disclosure, the value of N may be determined according to the classification type of the UE and/or the type of the target cell. Compared with the value of N being determined according to only the type of the target cell, the new value taking mode can save the handover time and improve the system efficiency while ensuring the compatibility with different types of UEs. In some implementations, N may be an integer greater than or equal to 0.

Optionally, if the target cell is a satellite access node (SAN for short) in a frequency range 2 of a non-terrestrial network or in other frequency ranges: if the target cell is an unknown intra-frequency cell and the Es/Iot of the target cell is greater than or equal to a third threshold (dB), T_{search}=N*Tᵣₛ ms. If the target cell is an unknown inter-frequency cell and the Es/Iot of the target cell is greater than or equal to the third threshold (dB), T_{search}=3*N*Tᵣₛ ms. In the embodiment of the present disclosure, the value of N may be determined according to the classification type of the UE and/or the type of the target cell. Similarly, compared with the value of N being determined according to only the type of the target cell, the new value taking mode can save the handover time and improve the system efficiency while ensuring the compatibility with different types of UEs. In some implementations, N may be an integer greater than or equal to 0.

The values of the first threshold, the second threshold and the third threshold may be or may not be equal.

Optionally, by taking the SAN in the FR2 of the non-terrestrial network being the target cell as an example, based on the above possible UE type classification example (e.g., Table 1), the following Table 4 is a possible mapping relationship between the value of N and the UE type classification according to an embodiment of the present disclosure:

TABLE 4

| UE type | Value of N |
|---|---|
| 1 | N = 1 |
| 2 | N = 8 |
| 3 | N = 1 |
| 4 | N = 1 |
| 5 | N = 1 |
| 6 | N = 1 |

It can be seen from the example shown in Table 4 that, if the original N=8 is reused, the T_{search} time for all different types of UEs is the same. After the mapping value based on the UE type is introduced, for the UE types 3, 4, 5 and 6, the corresponding N is 1, and the time required to search the target cell corresponding to these UEs is greatly reduced, so that the interruption time can be effectively reduced, and the overall efficiency of the communication system can be improved.

Optionally, in some implementations, N may also be implicitly embodied. For example, in the above situation where “if the target cell is an SAN in a frequency range 2 of a non-terrestrial network or in other frequency ranges: if the target cell is an unknown intra-frequency cell and the Es/Iot of the target cell is greater than or equal to a third threshold (dB), T_{search}=N*Tᵣₛ ms. If the target cell is an unknown inter-frequency cell and the Es/Iot of the target cell is greater than or equal to the third threshold, T_{search}=3*N*Tᵣₛ ms”, for the UE types 3, 4, 5 and 6, the search time may also be expressed as T_{search}=Tᵣₛ ms and T_{search}=³*Tᵣₛ ms, respectively.

In the embodiment of the present disclosure, the search time may be determined based on the information associated with the antenna configuration of the UE, but the expression form may not be limited.

With continued reference to the above equation (2), wherein, Ti is the interruption uncertainty of obtaining the first available PRACH occasion in the new cell; T_{processing} is the processing time of the UE; TA is the time for fine time tracking and obtaining the complete timing information of the target cell; T_{margin} is the post-processing time of the synchronization signal block (SSB); T_{antenna-adjust} is the above first time interval, describing the antenna adjustment time required in the handover process and/or the time required by the device to perform a circuit switching between different antennas; and Tᵣₛ is the SSB-based measurement timing configuration (SMTC) period of the target cell. This SMTC period may be provided to the UE through a handover instruction. If the period is not provided to the UE, the time period may be determined by any existing or future method. For example, Tᵣₛ may be the SMTC configured in measObjectNR with the same SSB frequency and subcarrier interval. For another example, if the NR measurement object message (measObjectNR) configured by a major node and a secondary node of the UE has different SMTCs, Tᵣₛ is the period of one of the SMTCs, depending on the UE implementation, or the like. This will not be limited in the embodiment of the present disclosure.

In the interruption requirement, if a cell always satisfies the related cell identification requirement in the last (or latest) 5 seconds, this cell is known; otherwise, this cell is unknown. The specific condition of distinguishing known and unknown cells may be determined by any existing or future method, and will not be limited in the embodiment of the present disclosure.

In the above-described embodiment of performing an ordinary cell handover by the UE, in the formula (1), the first time interval is use as a newly added time requirement in the cell handover delay requirement; and in the formula (2), the first time interval is used as a newly added time required in the interruption time in the cell handover delay. No matter in which form, the first time interval may be associated with the type of the UE or the information related to the type of the UE.

For the conditional handover in the cell handover, the handover delay requirement to be satisfied by the UE is that: when the UE receives an RRC message to instruct the UE to perform a cell handover to a new cell, the UE shall be ready to start the transmission of a new uplink PRACH within D_{CHO} s from the end of the last transmission time interval (TTI) containing the RRC command. In the embodiment of the present disclosure, for the handover delay requirement for the conditional handover, the newly added time interval (the first time interval in the conditional handover) may be added on the basis of the existing D_{CHO} time to describe the antenna adjustment time required by the UE in the handover process and the time required by the device to perform a circuit switching between different antennas. By adding this time interval, different time lengths may be set to adapt to different behaviors required by different types of UEs during handover, so that the overall handover efficiency of the communication system is improved.

For the newly added time interval, the T_{antenna-adjust} representation may still be taken as an example, and an example of D_{CHO} may be as follows:

$${D}_{CHO} = {T}_{RRC} + {T}_{Event\_DU} + {T}_{measure} + {T}_{interrupt} + {T}_{CHO\_execution} + {T}_{antenna - adjust} \qquad ( 3 )$$

where, T_{RRC} is the RRC procedure delay; T_{Event_DU} is the delay uncertainty, and this delay uncertainty is the time from when the UE successfully decode the conditional handover command to when there is a condition for triggering the conditional handover at the measurement reference point; Tₘₑₐₛᵤᵣₑ is the measurement time delay; T_{CHO_execution} is the preparation time for conditional execution; Tᵢₙₜₑᵣᵣᵤₚₜ is the interruption time; and T_{antenna-adjust} is the newly added first time interval, describing the antenna adjustment time required in the handover process and the time required by the device to perform a circuit switching between different antennas.

As an optional solution, a possible formula description of the first time interval may be expressed by the above formula (1). Optionally, the value of M, N or the first time interval T_{antenna-adjust} in the formula (1) may refer to the example shown in Table 3.

For the measurement time delay Tₘₑₐₛᵤᵣₑ in the above formula, in an optional embodiment of the present disclosure, the first measurement event, second measurement event and third measurement event described above are proposed, and different measurement events may correspond to the respective measurement time delays Tₘₑₐₛᵤᵣₑ.

Optionally, for the first measurement event, the measurement time delay means the end point of T_{Event_DU} until the UE performs a handover to the target cell and the start of the interruption time Tᵢₙₜₑᵣᵣᵤₚₜ. For the first measurement event, if the moment when the entering condition is satisfied (for example, the result of the distance between the UE and the reference location of the serving cell minus the offset is greater than or equal to the threshold 1 and/or the result of the distance between the UE and the reference location of the serving cell plus the offset is less than or equal to the threshold 2) is earlier than the T_{Event_DU} plus the cell identification delay parameter, the measurement time delay is equal to the cell identification delay parameter. In this optional solution, it is assumed that the UE only performs measurement within the SMTC window of the target cell. If the moment when the entering condition is satisfied is later than the T_{Event_DU} plus the cell identification delay parameter, the measurement time delay is equal to the end point of T_{Event_DU} until the moment when the entering condition is satisfied. In this optional solution, it is assumed that the UE only performs measurement within the SMTC window of the target cell.

Optionally, for the second measurement event, if the moment when the entering condition is satisfied (for example, the result of the elevation angle 1 after the UE is aligned with the serving satellite by mechanical scanning minus the lag offset is less than or equal to the threshold 3, and/or the result of the elevation angle 2 after the UE is aligned with the neighboring node by mechanical scanning plus the lag offset is greater than or equal to the threshold 4) is earlier than the T_{Event_DU} plus the cell identification delay parameter, the measurement time delay is equal to the cell identification delay parameter. In this optional solution, it is assumed that the UE only performs measurement within the SMTC window of the target cell. If the moment when the entering condition is satisfied is later than the T_{Event_DU} plus the cell identification delay parameter, the measurement time delay is equal to the end point of T_{Event_DU} until the moment when the entering condition is satisfied. In this optional solution, it is assumed that the UE only performs measurement within the SMTC window of the target cell.

Optionally, for the third measurement event, if the moment when the entering condition is satisfied (for example, the difference between the first time and the lag offset is less than or equal to the threshold 5, and/or the difference between the second time and the lag offset is less than or equal to the threshold 6) is earlier than the T_{Event_DU} plus the cell identification delay parameter, the measurement time delay is equal to the cell identification delay parameter. In this optional solution, it is assumed that the UE only performs measurement within the SMTC window of the target cell. If the moment when the entering condition is satisfied is later than the T_{Event_DU} plus the cell identification delay parameter, the measurement time delay is equal to the end point of T_{Event_DU} until the moment when the entering condition is satisfied. In this optional solution, it is assumed that the UE only performs measurement within the SMTC window of the target cell.

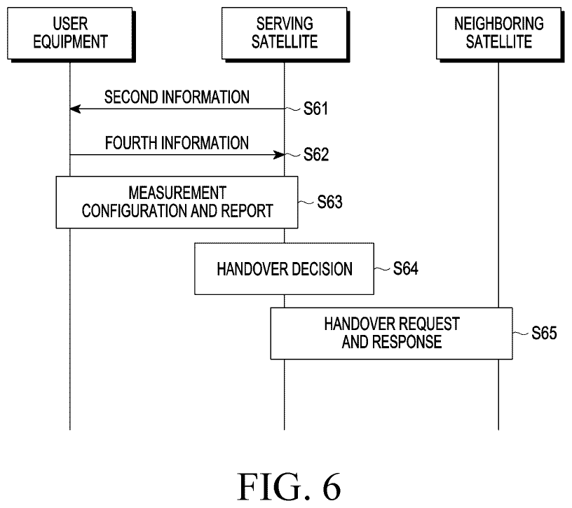

FIG. 6 illustrates a flowchart of another enhanced cell handover method based on the solution provided in the present disclosure. As shown in FIG. 6, the communication method in this embodiment may include the following steps.

In step S61, a base station or serving satellite periodically sends second information.

In step S62, a UE periodically reports fourth information after analyzing the second information last time.

In step S63, a measurement configuration and a report are performed.

In step S64, a handover decision is made.

In step S65, a handover request and a response are performed.

This embodiment differs from the embodiment shown in FIG. 5 in that: the serving satellite may periodically send the second information; and, upon receiving and analyzing the second information sent by the serving satellite, the UE may provide the fourth information to the serving satellite to assist the serving satellite to determine suitable handover parameters for the UE.

Optionally, the method in this embodiment may further include: sending third information by the base station or the serving satellite. The third information may be or may not be sent periodically. For example, the serving satellite may periodically send the second information and the third information, and the UE may report the fourth information to the serving satellite according to the second information and the third information. For another example, the serving satellite may periodically send the third information; and, the UE may report the third information to the serving satellite according to the third information received currently and the second information received last time, or the UE may only report the fourth information based on the third information when the second information associated with the third information is not received (for example, the second information and the third information are not received simultaneously).

The second information, the third information and the fourth information may refer to the corresponding description in the above embodiments, and the steps S63 to S65 after the UE sends the fourth information may refer to the description of the steps S54 to S56 in the embodiment shown in FIG. 5 and will not be repeated in this embodiment. Similarly, the handover delay requirement and/or the conditional handover delay requirement to be satisfied by the handover of the UE may be the same as those in the embodiment corresponding to FIG. 5 and will not be repeated again.

Corresponding to the method executed by a UE provided in the above embodiments of the present disclosure, an embodiment of the present disclosure further provides a method executed by a node in a wireless communication system. Optionally, this node may be a satellite or a base station, and this method may include the following steps of: receiving first information related to the type of a UE, and/or receiving fourth information used for assisting the configuration of measurement configuration information related to radio resource management (RRM); and sending the measurement configuration information.

The measurement configuration information may be determined/configured based on the received first information and/or fourth information.

It should be understood that this method is a method executed on a network side corresponding to the method executed by a UE, and the two methods are described by using a node and a UE as execution bodies, respectively, and have the same substantive content. Therefore, other optional implementation of this method may be obtained based on the above embodiments.

Optionally, the method further includes: sending second information, the second information including information related to the fourth information to be sent by the UE; wherein the fourth information is determined based on the second information.

Optionally, the second information includes at least one of the following: information related to at least one beam of a serving node of the UE; and information related to at least one beam of at least one neighboring node of the serving node; wherein the information related to a beam includes: at least one of the position information of the beam, the pointing direction of the beam, and the angle range of the beam.

Optionally, the method further includes: sending third information, the third information being used for requesting information to be reported by the UE.

Optionally, the fourth information is sent after the second information is received; or the second information is received periodically, and the fourth information is sent periodically.

Optionally, the second information is not sent when the UE is a first type of UE or is sent when the UE is a second type of UE, and the first type and the second type are different types.

Optionally, the fourth information includes at least one of the following: information related to the position of the UE; the beam pointing direction of the UE when sending the fourth information; and, an adjustment parameter used by the UE to mechanically scan and adjust antennas, the adjustment parameter including at least one of the following: tracking speed, angle adjustment range and angle adjustment accuracy.

Optionally, the information related to the position of the UE includes at least one of the following: position information of the UE; relative position information of the UE and at least one beam, the at least one beam including at least one beam in at least one of the following: at least one beam of the serving node of the UE; and at least one beam of at least one neighboring node of the serving node.

Optionally, the measurement configuration information includes at least one measurement event, and the at least one measurement event includes at least one of the following: a distance-related first event, the distance including a first distance between the UE and a beam of the serving node and/or a second distance between the UE and a beam of at least one neighboring node of the serving node; an angle-related second event, the angle including at least one of a first angle, a second angle, a third angle and a fourth angle, wherein the first angle is an angle when the UE is aligned with a beam of the serving node, the second angle is an angle when the UE is aligned with a beam of at least one neighboring node of the serving node, the third angle is an angle when the UE is aligned with the serving node, and the fourth angle is an angle when the UE is aligned with at least one neighboring node; and a time-related third event, the time including a first time and/or a second time, wherein the first time is related to a fifth angle and a tracking speed used by the UE to mechanically scan and adjust antennas, the fifth angle is an included angle between the pointing direction of a beam of the serving node and the pointing direction of a beam of at least one neighboring node of the serving node, and the second time is related to the angle after the UE is aligned with the serving node and the tracking speed used by the UE to mechanically scan and adjust antennas.

Optionally, an entering condition for the first event includes at least one of the following: the difference between the first distance and a first offset is greater than or equal to a first threshold, and the sum of the second distance and a second offset is less than or equal to a second threshold; and/or a leaving condition for the first event includes at least one of the following: the sum of the first distance and the first offset is less than or equal to the first threshold, and the difference between the second distance and the second offset is greater than or equal to the second threshold.

Optionally, an entering condition for the second event includes at least one of the following: the difference between the first angle and a third offset is less than or equal to a third threshold, the sum of the second angle and a fourth offset is greater than or equal to a fourth threshold, the difference between the third angle and a fifth offset is less than or equal to a fifth threshold, and the sum of the fourth angle and the sixth offset is greater than or equal to a sixth threshold; and/or a leaving condition for the second event includes at least one of the following: the sum of the first angle and the third offset is greater than or equal to the third threshold, the difference between the second angle and the fourth offset is less than or equal to the fourth threshold, the sum of the third angle and the fifth offset is greater than or equal to the fifth threshold, and the difference between the fourth angle and the sixth offset is less than or equal to the sixth threshold.

Optionally, an entering condition for the third event includes at least one of the following: the difference between the first time and a seventh offset is less than or equal to a seventh threshold, and the difference between the second time and an eighth offset is less than or equal to an eighth threshold; and/or a leaving condition for the third event includes at least one of the following: the sum of the first time and the seventh offset is greater than or equal to the seventh threshold, and the sum of the second time and the eighth offset is greater than or equal to the eighth threshold.

Optionally, the at least one measurement event is configured based on the type of the UE.

Optionally, the first threshold is not greater than a first value, wherein the first value is related to at least one of the following: ephemeris information of the serving node and/or neighboring node; the pointing direction of a beam of the serving node and/or neighboring node; the angle range of a beam of the serving node and/or neighboring node; the beam pointing direction of the UE when sending the fourth information; the tracking speed at which the UE mechanically scans antennas; the moving speed or preset speed of a satellite; and an angle tolerance range.

Optionally, the method further includes: receiving a measurement report; and sending a cell handover command to the UE when determining that the UE performs a cell handover, wherein a handover delay used for the cell handover of the UE includes at least one of the following: a third time, and a target cell search time; wherein the third time includes at least one of a fourth time and a fifth time, the fourth time is an antenna adjustment time required by the UE in a handover process, and the fifth time is a time required for a circuit switching between different antennas of the UE; and the target cell search time is related to the type of the UE.

Optionally, the type of the UE is related to at least one of the following: antenna configuration information of the UE; UE capability information; power class information of the UE; and antenna capability information of the UE.

Other optional solutions may refer to the description of the above embodiments.

An embodiment of the present disclosure further provides a user equipment in a wireless communication system, wherein the user equipment includes a transceiver and at least one processor coupled to the transceiver, and the at least one processor is configured to execute any method executed by a user equipment provided in the embodiments of the present disclosure.

An embodiment of the present disclosure further provides anode (or called anode device) in a wireless communication system, wherein the node includes a transceiver and at least one processor coupled to the transceiver, and the at least one processor is configured to execute any method executed by a node provided in the embodiments of the present disclosure.

An embodiment of the present disclosure further provides an electronic device, including a processor, and optionally a transceiver and/or memory coupled to the processor, wherein the processor is configured to execute the steps of the method provided in any one of the optional embodiments of the present disclosure.

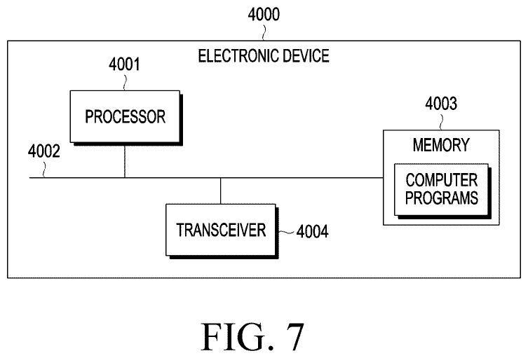

FIG. 7 shows a schematic structure diagram of an electronic device 4000 to which the solution of the embodiment of the present application is applied. As shown in FIG. 7, the electronic device 4000 shown in FIG. 7 may include a processor 4001 and a memory 4003. The processor 4001 is connected to the memory 4003, for example, through a bus 4002. Optionally, the electronic device 4000 may further include a transceiver 4004, and the transceiver 4004 may be used for data interaction between the electronic device and other electronic devices, such as data transmission and/or data reception. It should be noted that, in practical applications, the transceiver 4004 is not limited to one, and the structure of the electronic device 4000 does not constitute any limitations to the embodiments of the present application. Optionally, the electronic device may be a network node or user equipment.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute the various exemplary logical blocks, modules and circuits described in connection with this disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 7. However, it does not mean that there is only one bus or one type of buses.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store application program codes for executing the solutions of the present application, and is controlled by the processor 4001. The processor 4001 is used to execute the application program codes stored in the memory 4003 to implement the solution provided in any method embodiment described above.

In one aspect, an embodiment of the present disclosure provides a method executed by a user equipment (UE) in a wireless communication system, including: sending first information related to a type of the UE, and/or sending fourth information used for assisting a configuration of measurement configuration information related to radio resource management (RRM); and receiving the measurement configuration information, wherein the measurement configuration information is configured based on the first information and/or the fourth information.

In another aspect, an embodiment of the present disclosure provides a method executed by a node in a wireless communication system, including: receiving first information related to a type of a user equipment (UE), and/or receiving fourth information used for assisting a configuration of measurement configuration information related to radio resource management (RRM); and sending the measurement configuration information, wherein the measurement configuration information is configured based on the first information and/or the fourth information.

Optionally, the method further includes: sending second information, wherein the second information includes information related to the fourth information to be sent by the UE; wherein the fourth information is determined based on the second information.

Optionally, the second information includes at least one of the following: information related to at least one beam of a serving node of the UE, and information related to at least one beam of at least one neighboring node of the serving node, wherein the information related to the at least one beam of the serving node of the UE or the at least one beam of the at least one neighboring node of the serving node includes at least one of: position information of the at least one beam; a pointing direction of the at least one beam; a width of the at least one beam; and the angle range of the at least one beam.

Optionally, the method further includes: sending third information, wherein the third information is used for requesting information to be reported by the UE.

Optionally, the fourth information is received after the second information is sent; or the second information is sent periodically, and the fourth information is received periodically.

Optionally, the second information is not sent when the UE is a first type of UE or is sent when the UE is a second type of UE, wherein the first type of UE and the second type of UE are different types.

Optionally, the fourth information includes at least one of the following: information related to a position of the UE; a beam pointing direction of the UE when sending the fourth information; and an adjustment parameter used by the UE to mechanically scan and adjust antennas, wherein the adjustment parameter includes at least one of the following: a tracking speed, an angle adjustment range, and an angle adjustment accuracy.

Optionally, the information related to the position of the UE includes at least one of the following: position information of the UE; relative position information of the UE and at least one beam, wherein the at least one beam includes at least one beam in at least one of the following: a serving node of the UE; and at least one neighboring node of the serving node of the UE.

Optionally, the measurement configuration information includes at least one measurement event, wherein the at least one measurement event includes at least one of the following: a distance-related first event, wherein a distance of the distance-related first event includes a first distance between the UE and a beam of a serving node and/or a second distance between the UE and a beam of at least one neighboring node of the serving node; an angle-related second event, wherein an angle of the angle-related second event includes at least one of a first angle, a second angle, a third angle, and a fourth angle, wherein: the first angle is an angle when the UE is aligned with a beam of the serving node, the second angle is an angle when the UE is aligned with a beam of the at least one neighboring node of the serving node, the third angle is an angle when the UE is aligned with the serving node, and the fourth angle is an angle when the UE is aligned with the at least one neighboring node; a time-related third event, wherein a time of the time-related event includes a first time and/or a second time, wherein: the first time is related to a fifth angle and a tracking speed used by the UE to mechanically scan and adjust antennas, wherein the fifth angle is an included angle between a pointing direction of a beam of the serving node and a pointing direction of a beam of the at least one neighboring node of the serving node, and the second time is related to an angle after the UE is aligned with the serving node and the tracking speed used by the UE to mechanically scan and adjust antennas.

Optionally, an entering condition for the distance-related first event includes at least one of the following: a difference between the first distance and a first offset that is greater than or equal to a first threshold, and a sum of the second distance and a second offset that is less than or equal to a second threshold; and/or a leaving condition for the distance-related first event includes at least one of the following: a sum of the first distance and the first offset that is less than or equal to the first threshold, and a difference between the second distance and the second offset that is greater than or equal to the second threshold.

Optionally, an entering condition for the angle-related second event includes at least one of the following: a difference between the first angle and a third offset that is less than or equal to a third threshold, a sum of the second angle and a fourth offset that is greater than or equal to a fourth threshold, a difference between the third angle and a fifth offset that is less than or equal to a fifth threshold, and a sum of the fourth angle and a sixth offset that is greater than or equal to a sixth threshold; and/or a leaving condition for the angle-related second event includes at least one of the following: a sum of the first angle and the third offset that is greater than or equal to the third threshold, a difference between the second angle and the fourth offset that is less than or equal to the fourth threshold, a sum of the third angle and the fifth offset that is greater than or equal to the fifth threshold, and a difference between the fourth angle and the sixth offset that is less than or equal to the sixth threshold.

Optionally, an entering condition for the time-related third event includes at least one of the following: a difference between the first time and a seventh offset that is less than or equal to a seventh threshold, and a difference between the second time and an eighth offset that is less than or equal to an eighth threshold; and/or a leaving condition for the time-related third event includes at least one of the following: a sum of the first time and the seventh offset that is greater than or equal to the seventh threshold, and a sum of the second time and the eighth offset that is greater than or equal to the eighth threshold.

Optionally, the at least one measurement event is configured based on the type of the UE.

Optionally, the first threshold is not greater than a first value, wherein the first value is related to at least one of the following: ephemeris information of the serving node and/or the neighboring node; the pointing direction of a beam of the serving node and/or the neighboring node; the angle range of a beam of the serving node and/or the neighboring node; the beam pointing direction of the UE when sending the fourth information; the tracking speed at which the UE mechanically scans antennas; the moving speed or preset speed of a satellite; and an angle tolerance range.

Optionally, the method further includes: receiving a measurement report; and sending a cell handover command to the UE when determining that the UE performs a cell handover, wherein a handover delay used for the cell handover of the UE includes at least one of the following: a third time, and a target cell search time; wherein the third time includes at least one of a fourth time and a fifth time, wherein the fourth time is an antenna adjustment time required by the UE in a handover process, wherein the fifth time is a time required for a circuit switching between different antennas of the UE; the target cell search time is related to the type of the UE.

Optionally, the type of the UE is related to at least one of the following: antenna configuration information of the UE; UE capability information; power class information of the UE; and antenna capability information of the UE.

In still another aspect, an embodiment of the present disclosure provides a user equipment in a wireless communication system, wherein the user equipment includes a transceiver and at least one processor coupled to the transceiver, wherein the at least one processor is configured to execute the method executed by a user equipment provided in any one of the embodiments of the present disclosure.

In yet another aspect, an embodiment of the present disclosure provides a node device in a wireless communication system, wherein the node device includes a transceiver and at least one processor coupled to the transceiver, wherein the at least one processor is configured to execute the method executed by a node provided in any one of the embodiments of the present disclosure.

In yet another aspect, an embodiment of the present disclosure further provides a computer-readable storage medium having computer programs stored thereon that, when run by a processor, execute the method provided in any one of the embodiments of the present disclosure.

In yet another aspect, a computer program product is provided, including computer programs that, when run by a processor, execute the method provided in any one of the optional embodiments of the present disclosure.

The beneficial effects achieved by the technical solutions provided in the embodiments of the present disclosure will be described below by specific embodiments.

Embodiments of the present disclosure provide a computer-readable storage medium having a computer program stored on the computer-readable storage medium, the computer program, when executed by a processor, implements the steps and corresponding contents of the foregoing method embodiments.

Embodiments of the present disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the present disclosure described herein can be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present disclosure are not limited thereto.

The above-mentioned description and the drawings are provided merely as examples to help readers to understand the present disclosure, and they should not be interpreted or aim to limit the scope of the present disclosure in any way. Although certain embodiments and examples have been provided, based on what is disclosed herein, it will be apparent to those skilled in the art that the embodiments and examples shown may be altered without departing from the scope of the present disclosure. Employing other similar means of implementation based on the technical ideas of the present disclosure also fall within the scope of protection of embodiments of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
transmitting, to a serving node, assistance information for a configuration of measurement configuration information related to radio resource management (RRM); and
receiving, from the serving node, the measurement configuration information.

2. The method of claim 1, further comprising:
transmitting, to the serving node, first information related to a type of the UE; and
receiving, from the serving node, second information, wherein the second information includes information related to the assistance information,
wherein the first information and the second information are used for the measurement configuration information.

3. The method of claim 2, wherein the second information further includes at least one of:
information related to at least one beam of the serving node of the UE, and
information related to at least one beam of at least one neighboring node of the serving node,
wherein the information related to the at least one beam of the serving node of the UE or the information related to the at least one beam of the at least one neighboring node includes at least one of:
position information of the at least one beam,
a pointing direction of the at least one beam,
a width of the at least one beam, and
an angle range of the at least one beam.

4. The method of claim 1, further comprising:
receiving, from the serving node, third information, wherein the third information is used for requesting information to be reported by the UE.

5. The method of claim 2,
wherein the assistance information is transmitted after the second information is received,
wherein the second information is received periodically and the assistance information is transmitted periodically, or
wherein the second information is not received in case that the UE is a first type of UE or is received in case that the UE is a second type of UE, wherein the first type of UE and the second type of UE are different types.

6. The method of claim 2,
wherein the assistance information includes at least one of:
information related to a position of the UE;
a beam pointing direction of the UE when sending the assistance information; and
an adjustment parameter used by the UE to mechanically scan and adjust antennas,
wherein the adjustment parameter includes at least one of:
a tracking speed;
an angle adjustment range; and
an angle adjustment accuracy,
wherein the information related to the position of the UE includes at least one of:
position information of the UE; and
relative position information of the UE and at least one beam, and
wherein the at least one beam includes at least one beam in at least one of:
the serving node of the UE; and
at least one neighboring node of the serving node of the UE.

7. The method of claim 2,
wherein the measurement configuration information comprises at least one measurement event, wherein the at least one measurement event includes at least one of:
a distance-related first event, wherein a distance of the distance-related first event includes a first distance between the UE and a beam of the serving node or a second distance between the UE and a beam of at least one neighboring node of the serving node;
an angle-related second event, wherein an angle of the angle-related second event includes at least one of a first angle, a second angle, a third angle, and a fourth angle, wherein:
the first angle is an angle when the UE is aligned with a beam of the serving node,
the second angle is an angle when the UE is aligned with a beam of the at least one neighboring node of the serving node,
the third angle is an angle when the UE is aligned with the serving node, and
the fourth angle is an angle when the UE is aligned with the at least one neighboring node; and
a time-related third event, wherein a time of the time-related event comprises a first time or a second time, wherein:
the first time is related to a fifth angle and a tracking speed used by the UE to mechanically scan and adjust antennas, wherein the fifth angle is an included angle between a pointing direction of a beam of the serving node and a pointing direction of a beam of the at least one neighboring node of the serving node, and
the second time is related to an angle after the UE is aligned with the serving node and the tracking speed used by the UE to mechanically scan and adjust antennas.

8. The method of claim 7,
wherein an entering condition for the distance-related first event includes at least one of:
a difference between the first distance and a first offset that is greater than or equal to a first threshold, and
a sum of the second distance and a second offset that is less than or equal to a second threshold;
wherein a leaving condition for the distance-related first event includes at least one of:
a sum of the first distance and the first offset that is less than or equal to the first threshold, and
a difference between the second distance and the second offset that is greater than or equal to the second threshold;
wherein an entering condition for the angle-related second event includes at least one of:
a difference between the first angle and a third offset that is less than or equal to a third threshold,
a sum of the second angle and a fourth offset that is greater than or equal to a fourth threshold,
a difference between the third angle and a fifth offset that is less than or equal to a fifth threshold, and
a sum of the fourth angle and a sixth offset that is greater than or equal to a sixth threshold;
wherein a leaving condition for the angle-related second event includes at least one of:
a sum of the first angle and the third offset that is greater than or equal to the third threshold,
a difference between the second angle and the fourth offset that is less than or equal to the fourth threshold,
a sum of the third angle and the fifth offset that is greater than or equal to the fifth threshold, and
a difference between the fourth angle and the sixth offset that is less than or equal to the sixth threshold;
wherein an entering condition for the time-related third event includes at least one of:
a difference between the first time and a seventh offset that is less than or equal to a seventh threshold, and
a difference between the second time and an eighth offset that is less than or equal to an eighth threshold; or
wherein a leaving condition for the time-related third event includes at least one of:
a sum of the first time and the seventh offset that is greater than or equal to the seventh threshold, and
a sum of the second time and the eighth offset that is greater than or equal to the eighth threshold.

9. The method of claim 8, wherein the at least one measurement event is configured based on the type of the UE.

10. The method of claim 8,
wherein the first threshold is not greater than a first value, and
wherein the first value is related to at least one of:
ephemeris information of the serving node or the neighboring node;
the pointing direction of a beam of the serving node or the neighboring node;
the angle range of a beam of the serving node or the neighboring node;
the beam pointing direction of the UE when sending the fourth information;
the tracking speed at which the UE mechanically scans antennas;
a moving speed or preset speed of a satellite; and
an angle tolerance range.

11. The method of claim 1, further comprising:
transmitting, to the serving node, a measurement report based on the measurement configuration information; and
performing a cell handover after a cell handover command is received,
wherein a handover delay information used for the cell handover of the UE includes at least one of a third time and a target cell search time,
wherein:
the third time includes at least one of a fourth time and a fifth time, wherein the fourth time is an antenna adjustment time required by the UE in a handover process, wherein the fifth time is a time required for a circuit switching between different antennas of the UE; and
the target cell search time is related to the type of the UE.

12. The method of claim 2, wherein the type of the UE is related to at least one of:
antenna configuration information of the UE;
UE capability information;
power class information of the UE; and
antenna capability information of the UE.

13. A method performed by a serving node in a wireless communication system, the method comprising:
receiving, from a user equipment (UE), assistance information for a configuration of measurement configuration information related to radio resource management (RRM); and
transmitting, to the UE, the measurement configuration information.

14. The method of claim 13, further comprising:
receiving, from the UE, first information related to a type of the UE; and
transmitting, to the UE, second information, wherein the second information includes information related to the assistance information to be sent by the UE,
wherein the first information and the second information are used for the measurement configuration information.

15. The method of claim 14, wherein the second information further includes at least one of:
information related to at least one beam of the serving node of the UE, and
information related to at least one beam of at least one neighboring node of the serving node,
wherein the information related to the at least one beam of the serving node of the UE or the information related to the at least one beam of the at least one neighboring node includes at least one of:
position information of the at least one beam,
a pointing direction of the at least one beam,
a width of the at least one beam, and
an angle range of the at least one beam.

16. The method of claim 13, further comprising:
transmitting, to the UE, third information, wherein the third information is used for requesting information to be reported by the UE.

17. A user equipment (UE) in a wireless communication system, the UE comprising:
a transceiver; and
at least one processor coupled to the transceiver and configured to:
transmit, to a serving node, assistance information for a configuration of measurement configuration information related to radio resource management (RRM), and
receive, from the serving node, the measurement configuration information.

18. The UE of claim 17, wherein the at least one processor is further configured to:
transmit, to the serving node, first information related to a type of the UE and
receive, from the serving node, second information, wherein the second information includes information related to the assistance information,
wherein the first information and the second information are used for the measurement configuration information.

19. A serving node of a user equipment (UE) in a wireless communication system, the serving node comprising:
a transceiver; and
at least one processor coupled to the transceiver and configured to:
receive, from the UE, assistance information for a configuration of measurement configuration information related to radio resource management (RRM), and
transmit, to the UE, the measurement configuration information.

20. The serving node of claim 19, wherein the at least one processor is further configured to:
receive, from the UE, first information related to a type of the UE, and
transmit, to the UE, second information, wherein the second information includes information related to the assistance information to be sent by the UE,
wherein the first information and the second information are used for the measurement configuration information.
